(19) United States
(12) Patent Application Publication
(10) Pub. No.: US 2026/0030917 A1
(43) Pub. Date: Jan. 29, 2026

(54) BIOMETRIC RECOGNITION DEVICE FOR PALM PRINTS AND PALM VEINS AND IDENTITY AUTHENTICATION METHOD

(71) Applicant: Qingdao O-Mec Biometrics Co., Ltd., Qingdao (CN)

(72) Inventors: Jinwook YI, Qingdao (CN); Yuelin LI, Qingdao (CN); Huabin XU, Qingdao (CN)

(73) Assignee: Qingdao O-Mec Biometrics Co., Ltd., Qingdao (CN)

(21) Appl. No.: 18/995,866

(22) PCT Filed: Jul. 19, 2022
(86) PCT No.: PCT/CN2022/106521

§ 371 Date: Jan. 17, 2025

(51) Int. Cl. G06V 40/13; G06V 10/14; G06V 40/12; G06V 40/145

(52) U.S. Cl. CPC G06V 40/1312; G06V 10/14; G06V 40/1365; G06V 40/145

(57) ABSTRACT

A biometric recognition device for palm prints and palm veins includes: a light source being used to emit illuminating beams in a near-infrared band; a polarizing unit being used to convert the illuminating beams to polarized beams which are emitted to a palm; an imaging unit receiving retroreflected beams from a palm and being used to converge the retroreflected beams to a focal plane; a polarizing beam splitter forming transmitted beams and reflected beams based on different polarization directions of beams from the imaging unit, wherein the transmitted beams propagate after pass through the polarizing beam splitter, and the reflected beams propagate after reflected by the polarizing beam splitter. An identity authentication method is further provided. Based on the non-contact technical solution, only one light source is used to obtain the palm print images and palm vein images at the same time and in the same space.

### CROSS REFERENCE TO THE RELATED APPLICATIONS

This application is the national phase entry of International Application No. PCT/CN2022/106521, filed on Jul. 19, 2022, the entire contents of which are incorporated herein by reference.

### TECHNICAL FIELD

The present disclosure relates to a biometric recognition device for palm prints and palm veins and an identity authentication method.

### BACKGROUND

In the biometric recognition process, the human palm print information can be collected to perform the identity authentication, and the human palm vein information can also be collected to perform identity authentication.

In a palm print recognition way, texture features of the surface skin of the palm are obtained and the feature point data can be extracted from the texture features. Compared with the fingerprint recognition, the palm print recognition can collect features of a larger area and obtain richer feature points, so that the recognition and comparison process can be completed more accurately. The technical principle of palm print recognition uses a contact measurement way. In this way, the palm is placed on a collection plane (usually a glass prism), illuminating beams are used to illuminate the area of the palm, and an image capture device is used to capture the surface texture pattern (i.e. palm prints) of the palm. The feature points of the texture pattern are extracted to form a feature point template. During the identity authentication process, the collected feature point data are compared with the stored feature point template. When the comparison result is greater than a predefined threshold, the identity authentication is successful. However, since the human palm is not completely flat, and there are depressions on the palm area and protrusions on the thumb area, it is difficult to obtain perfect surface information by this contact measurement way for obtaining the palm prints. In addition, the size of the collection area of the device must be at least larger than the size of the palm, which increases the size of the device.

A palm vein recognition way is an emerging technology in the field of the biometric recognition. The way uses an image device to collect a palm vein pattern below the surface skin of the palm, and extracts feature points from the palm vein pattern to form feature point template for the identity authentication. Because the biometric information of the palm vein is hidden inside the palm tissue, the biometric information is not easily stolen compared to the fingerprint recognition, the palm print recognition, and the face recognition, and is therefore considered to have higher security. Specifically, the palm vein recognition adopts the principle that the deoxygenated hemoglobin in blood vessels has a stronger absorption capacity of specific wavelength light than other biological tissues. Near-infrared beams are used to illuminate the palm, and the palm is photographed with an image capture device. The tissue below the skin of the palm will form highlight areas in the image, while the veins absorb the near-infrared beams to form dark areas in the image. After obtaining the image of the palm veins, the feature points of the palm veins are extracted to form a feature point template. During the identity authentication process, the collected feature point data of the palm veins are compared with the stored feature point template. When the comparison result is greater than a predefined threshold, the identity authentication is successful. However, the thickness of palm veins and the ability of a specific wavelength light to pass through the skin and epidermal tissue will affect the effect of the vein imaging. Therefore, for special groups (slender palm veins or thick hand fat layer), the quality of the vein imaging depends on the high resolution of the image and the strong illumination emitted by a device.

For the palm print feature information, because the palm prints are on the surface skin, the palm prints are easy to be observed and obtained, so there is a risk of theft and forgery. In addition, some surface foreign matter such as scars, dust, oil on the palm will increase failure times for recognition, the misrecognition rate will increase accordingly. The characteristic information of the palm veins is almost impossible to be observed usually, and is difficult to be obtained by ordinary means, so the risk of the characteristic information being falsified is low. However, due to the different distribution of the palm veins for each person, the palm vein information of some people is unclear, and the blood vessels of some people are thin, which will increase the times of misrecognition and the misrecognition rate.

Compared with using the palm print recognition or the palm vein recognition alone, using both the palm print recognition and the palm vein recognition can obtain and use two different biometric information of the palm at the same time to further improve the recognition accuracy. Therefore, obtaining the characteristic information of the palm prints and the palm veins at the same time, and combining the characteristic information of the two recognitions, can not only eliminate the shortcomings of the two recognitions, but also ensure a faster recognition speed and a better accuracy than a single-modal recognition.

In the multi-modal recognition for a biometric recognition, such as the multi-modal recognition of a face recognition and a fingerprint recognition, and the multi-modal recognition of a face recognition and an iris recognition, two biometric information are independently collected from different parts of the human body, and thus the obtained feature information is completely independent. In these recognitions, the ways and the requirements for collecting information are relatively loose. For example, in the multi-modal recognition including the face recognition and the fingerprint recognition, the image sensor that obtains the face image and the image sensor that obtains the fingerprint image are two independent devices. It is not necessary to execute the two devices at the same time, and only needs to confirm that the two biometric characteristics belong to the same person. Compared with the existing methods, the present disclosure aims to provide a technology by obtaining the palm print and palm vein image at the same time and in the same space.

The palm prints and the palm veins are on the surface skin and inside the surface skin of the palm respectively. Therefore, in order to obtain the two kinds of feature information at the same time and in the same space, it is necessary to detect the inside and outside of the palm at the same time. From the perspective of optical image imaging principles, it is difficult to obtain simultaneously the images of the surface skin and the interior of the palm and separate the two kinds of feature information if only one kind of light source is used. The Publication Nos. CN102567707A and US2019/0392189A1 provide the recognition methods for palm prints and palm veins, but cannot solve the problem of acquiring images at the same time.

There are currently two ways to recognize the palm prints and palm veins. The first way is to emit illuminating beams of two different wavelengths at the same time (for example, as shown in FIG. 1, information can be collected at the same time but cannot be collected in the same space); The second way is to alternately emit illuminating beams of the same wavelength (for example, as shown in FIG. 2, information can be collected in the same space but cannot be collected at the same time).

In the first way, in order to obtain palm print images and palm vein images, an active light source is used to simultaneously emit the near-infrared beams and the visible beams to illuminate the palm, and the palm vein images are formed by an infrared image capture device and the palm vein images are formed by a visible beams image capture device.

In the process of capturing the palm print images and the palm vein images, if the first way is adopted, mutual interference effects caused by two beams of different characteristics will occur. Because the surface skin of the palm can reflect a part of the beams, the skin color observed is the image formed by the beams reflected on the surface skin to the eyes. Long-wave beams, such as the near-infrared beams, can penetrate the surface skin and reach the palm interior tissue that is 2-3 mm below the surface skin, and form scattered beams. Therefore, in the first way, the simplest technology is to use one light source with two wavelength bands, such as using visible beams to capture the palm print images and using the near-infrared beams to capture the palm vein images. However, when two light sources are used to capture the palm print images and the palm vein images, the beams of the two light sources are reflected and scattered by the palm. In the light path between the palm and the image sensor, an optical color filter must be used to block the beams of one light source and allow the beams of the other light source to pass, by which the interference will be eliminated. Furthermore, due to different wavelengths, the focus positions of imaging after passing through the lens are different. The light path design that uses the same optical axis and uses a dichroic prism to distinguish beams of different wavelengths will result in different image resolutions after two kinds of beams is imaged by the image sensors. Therefore, it is necessary to use two different lenses to achieve imaging, and make the optical design according to the wavelengths to ensure that both beams reach the desired resolution. However, this way will use two lenses and cause the problem of being unable to image in the same space, for example differences in field of view of the palm images as shown in FIG. 3.

With two kinds of beams, the visible beams reflected from the surface skin of the palm is stronger and form a brighter palm texture image in the whole image. However, after the near-infrared beams penetrates the surface skin, it is scattered inside the tissue, and the palm vein image of the whole image is weaker. The difference between the palm texture image and the palm vein image is quite large. It has a negative impact to the later operations and comparisons. In addition, when the near-infrared beams reach the surface skin of the palm, one part of the near-infrared beams will pass through the skin, and the other part of the near-infrared beams will be reflected into the lens through the reflection of the skin. Therefore, in the light path imaging of the near-infrared illumination, the texture of the surface skin of the palm will also be shown. The result is that the separation of palm prints and palm veins is not obvious, as shown in FIG. 4. The palm prints and the palm veins are not clearly separated.

In the second way, for example the Publication No. US2019/0392189A1 uses one light source emitting beams alternately and one or two image sensors, the images are acquired based on the lighting time of two kinds of beams to form the palm print image and the palm vein image alternately. Because the illuminating beams alternately flashes, there are startup times and shutdown times of the illumination. After the illumination is started, the image sensor must complete the exposure and imaging of one frame of image, so it is difficult to achieve high frame rate imaging.

Furthermore, in the second way, it is impossible to capture the palm prints images and the palm veins images at the same time. The algorithm needs to calculate the coordinate of the palm print feature point data and the coordinate of the palm vein feature point data of the same palm, which increases the amount of calculation. Due to the lens distortion and the time difference of the palm movement, the imaging positions of the palm print image and the palm vein image will be different. Normalizing to the same coordinate system also requires more distortion correction calculations, which reduces the recognition speed. There is a time difference between the palm print images and the palm vein images. In the non-contact palm imaging, the user's palm is not restricted in the three-dimensional space, and the palm position will continue to change. Therefore, the coordinate of the palm prints and the coordinate of the palm veins will be quite different. The difference will increase the calculation amount of the algorithm and reduce the speed of comparison and identification. It is also unable to effectively realize the living body detection function simultaneously.

### SUMMARY

In order to solve one of the foregoing technical problems, the present disclosure provides a biometric recognition device for palm prints and palm veins and an authentication method.

According to one aspect of the present disclosure, a biometric recognition device for palm prints and palm veins, including: a light source being used to emit illuminating beams in a near-infrared band; a polarizing unit being used to convert the illuminating beams to polarized beams which are emitted to a palm; an imaging unit receiving retroreflected beams from a palm and being used to converge the retroreflected beams to a focal plane; a polarizing beam splitter forming transmitted beams and reflected beams based on different polarization directions of beams from the imaging unit, wherein the transmitted beams propagate after pass through the polarizing beam splitter, and the reflected beams propagate after reflected by the polarizing beam splitter; a first image sensor receiving the transmitted beams from the polarizing beam splitter to form one kind of palm print images and palm vein images; and a second image sensor receiving the reflected beams from the polarizing beam splitter to form other kind of the palm print images and the palm vein images.

According to the biometric recognition device of at least one embodiment of the present disclosure, a polarization direction of the transmitted beams is the same as a polarization direction of the retroreflected beams, and a polarization direction of the reflected beams is perpendicular to the polarization direction of the retroreflected beams; or the polarization direction of the transmitted beams is perpendicular to the polarization direction of the retroreflected beams, and the polarization direction of the reflected beams is the same as the polarization direction of the retroreflected beams.

According to the biometric recognition device of at least one embodiment of the present disclosure, further including an optical color filter, the optical color filter is disposed in a light path between the palm and the first image sensor and/or the second image sensor to filter out beams outside an expected band.

According to the biometric recognition device of at least one embodiment of the present disclosure, the optical color filter is disposed between the palm and the imaging unit, between the imaging unit and the polarizing beam splitter, between the polarizing beam splitter and the first image sensor, and/or between the polarizing beam splitter and the second image sensor.

According to the biometric recognition device of at least one embodiment of the present disclosure, the near-infrared band ranges from 760 nm to 1100 nm.

According to the biometric recognition device of at least one embodiment of the present disclosure, the illuminating beams are arranged such that one part of the polarized beams is reflected by a surface skin of the palm to form first retroreflected beams, and the other part of the polarized beams, after passes through the surface skin of the palm and reaches internal tissue of the palm tissue, is scattered and diffused to form second retroreflected beams, wherein the polarization direction of the first retroreflected beams is the same as the polarization direction of the polarized beams, and the second retroreflected beams at least include second retroreflected sub-beams having a polarization direction being perpendicular to the polarization direction of the polarized beams.

According to the biometric recognition device of at least one embodiment of the present disclosure, the second retroreflected beams further include second retroreflected sub-beams having the same polarization direction as the polarization direction of the polarized beams.

According to the biometric recognition device of at least one embodiment of the present disclosure, the polarizing beam splitter is coated with the polarizing beam splitting film to separate the beams from the imaging unit into the transmitted beams and the reflected beams.

According to the biometric recognition device of at least one embodiment of the present disclosure, the polarizing beam splitting film is configured such that the first retroreflected beams and the second retroreflected sub-beams having the same polarization direction as the polarized beams pass through the polarizing beam splitting film to form the transmitted beams, and the second retroreflected sub-beams having the polarization direction being perpendicular to the polarization direction of the polarized beams are reflected to form the reflected beams; or the polarizing beam splitting film is configured such that the second retroreflected sub-beams having the polarization direction being perpendicular to the polarization direction of the polarized beams pass through the polarizing beam splitting film to form the transmitted beams, and the first retroreflected beams and the second retroreflected sub-beams having the same polarization direction as the polarized beams pass through the polarizing beam splitting film to form the reflected beams.

According to the biometric recognition device of at least one embodiment of the present disclosure, further including a distance sensor, wherein the distance sensor is used to measure a distance of the palm, and the light source, the first image sensor and the second image sensor are turned on when the distance of the palm is less than a predetermined distance.

According to another aspect of the present disclosure, an identity authentication method using the biometric recognition device of any one of the biometric recognition device mentioned above, including, obtaining the one kind of images formed by the first image sensor, comparing the one kinds of images with prestored feature information of the one kind of images, and performing a first identity authentication based on the one kind of images; obtaining the other kind of images formed by the second image sensor, comparing the other kind of images with prestored feature information of the other kind of images, and performing a second identity authentication based on the other kind of images; and implementing a final identity authentication based on the first identity authentication and the second identity authentication.

Compared with the technology using the simply “1+1” way to achieve multi-modal recognition, the biometric recognition way for palm prints and palm veins of the present disclosure has a more advanced and effective composition and method. The purpose of the biometric recognition way is to completely eliminate the possibility of falsifying data in the biometric recognition process, thereby greatly improving the accuracy of the biometric recognition and improving the security of biometric technology. To this end, the way of the disclosure implements the technology based on obtaining palm print and palm vein images at the same time and in the same space.

### BRIEF DESCRIPTION OF THE DRAWINGS

The accompanying drawings show exemplary implementations of the present disclosure and, together with the description, explain the principles of the present disclosure. These accompanying drawings are included to provide a further understanding of the present disclosure and are incorporated in and constitute a part of this specification.

FIG. 1 is an illustrative drawing of a palm print and palm vein recognition method in the prior art.

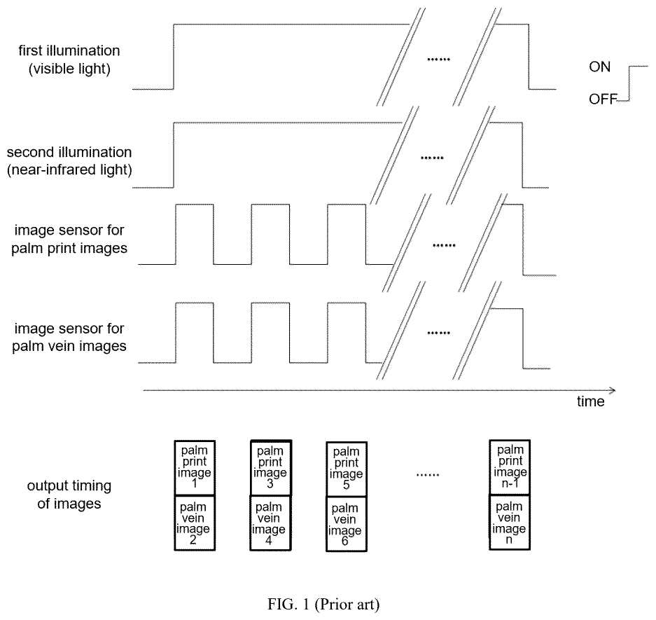

FIG. 2 is an illustrative drawing of a palm print and palm vein recognition method in the prior art.

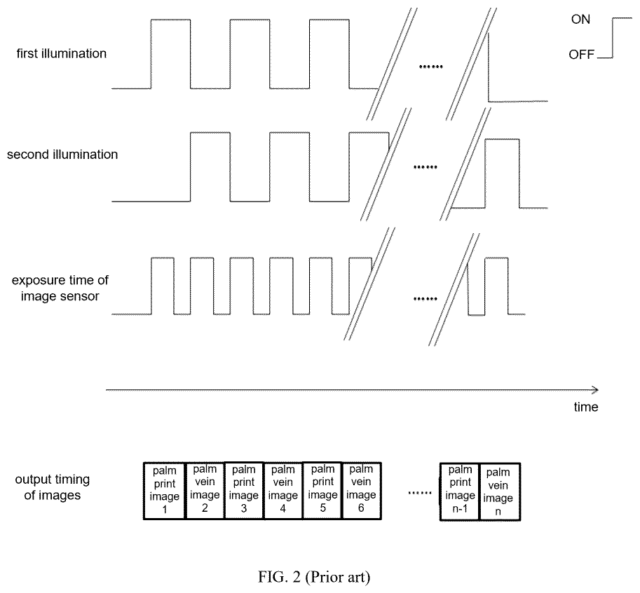

FIG. 3 is a recognition result according to the prior art.

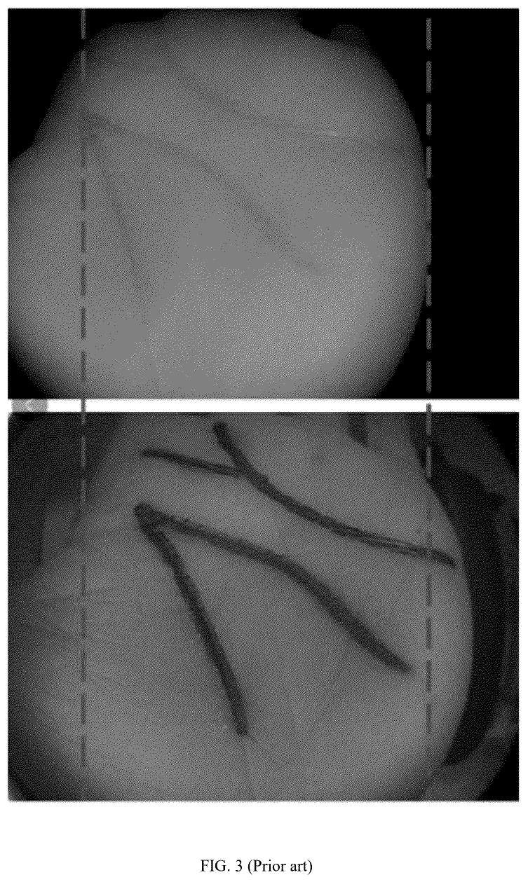

FIG. 4 is a recognition result according to the prior art.

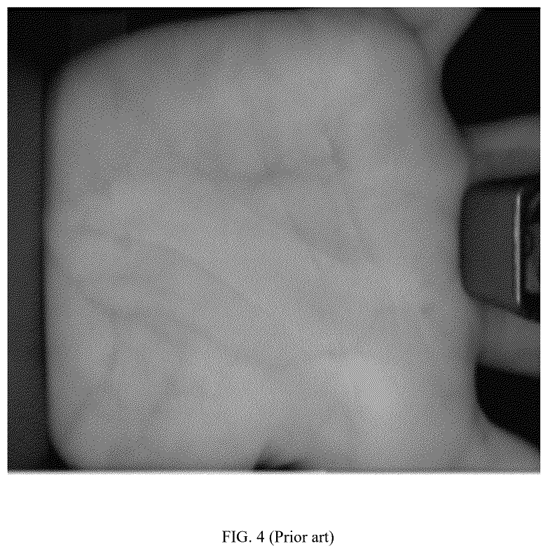

FIG. 5 is an illustrative drawing of a biometric recognition device for palm prints and palm veins according to an embodiment of the present disclosure.

FIG. 6 is an illustrative drawing of filtering of an optical color filter according to an embodiment of the present disclosure.

FIG. 7 is an illustrative drawing of a biometric recognition device for palm prints and palm veins according to an embodiment of the present disclosure.

FIG. 8 is an illustrative drawing of a biometric recognition device for palm prints and palm veins according to an embodiment of the present disclosure.

FIG. 9 is an illustrative drawing of a biometric recognition device for palm prints and palm veins according to an embodiment of the present disclosure.

FIG. 10 is an illustrative flow chart of a biometric authentication method for palm prints and palm veins according to an embodiment of the present disclosure.

### DETAILED DESCRIPTION OF THE EMBODIMENTS

The present disclosure is further described in detail below with reference to the accompanying drawings and implementations. It can be understood that the specific implementations described herein are only used to explain related content, but are not intended to limit the present disclosure. It should be further noted that, for ease of description, only a part related to the present disclosure is shown in the accompany drawings.

It should be noted that, on the premise of no conflict, the implementations in the present disclosure and features in the implementations may be combined with each other. Technical solutions of the present disclosure are described in detail below with reference to the accompanying drawings in conjunction with the implementations.

Unless otherwise specified, the illustrated exemplary implementations/embodiments are understood as providing exemplary features of various details of some ways in which technical concepts of the present disclosure may be implemented in practice. Therefore, unless otherwise specified, the features of various implementations/embodiments may be additionally combined, separated, interchanged, and/or rearranged without departing from the technical concepts of the present disclosure.

The use of crosshatch and/or shade in the accompanying drawings is generally used to make a boundary between adjacent parts clear. In this case, unless otherwise specified, the presence or absence of the crosshatch or shade does not express or indicate any preference or requirement for a specific material, material property, size, proportion of a part, commonality between illustrated parts, and/or any other characteristic, attribute, property, and the like of the part. In addition, in the accompanying drawings, a size and a relative size of a part may be exaggerated for clarity and/or a purpose of description. When exemplary embodiments may be implemented differently, a specific process sequence may be performed in an order different from an order described. For example, two consecutively described processes may be performed substantially simultaneously or in an order reverse to an order described. In addition, the same reference numerals denote the same part.

When a part is referred to as being “on” or “over”, “connected to”, or “coupled to” another part, this part may be directly on, connected to, or coupled to another part, or an intermediate part may exist. However, when a part is referred to as being “directly on”, “directly connected to”, or “directly coupled to” another part, an intermediate part does not exist. Therefore, the term “connected” may refer to physically connected, electrically connected, and the like, and an intermediate part exists or does not exist.

For a purpose of description, the present disclosure may use spatially relative terms such as “beneath”, “below”, “under”, “lower”, “above”, “upper”, “on”, “higher”, and “side (for example, in a “sidewall”)” to describe a relationship between one part and another (other) part as shown in the accompanying drawings. The spatially relative terms are intended to include different orientations of a device in use, operation, and/or manufacturing in addition to the orientations depicted in the accompanying drawings. For example, if the device in the accompanying drawings is turned over, a part that is described as “below” or “beneath” another part or feature is then located “above” the other part or feature. Therefore, the exemplary term “below . . . ” may include two orientations: “above” and “below”. In addition, the device may be further located (for example, the device is rotated 90 degrees or at another orientation). In this case, the spatially relative terms used herein are explained accordingly.

The terms used herein are for a purpose of describing specific embodiments and are not intended to put a limit. As used herein, unless otherwise clearly specified in the context, singular forms “one” (“a” and “an”) and “said (the)” are intended to include plural forms as well. In addition, when used in this specification, the terms “comprise” and/or “include” and variations thereof indicate presence of the described features, entireties, steps, operations, parts, assemblies and/or a combination thereof, but does not exclude presence or addition of one or more other features, entireties, steps, operations, parts, assemblies and/or a combination thereof. It should be further noted that, as used herein, the terms “substantially” and “about”, and other similar terms are used as approximate terms rather than degree terms, and therefore, they are used to explain an inherent deviation that is of a measured value, a calculated value, and/or a provided value and that will be recognized by those of ordinary skill in the art.

According to an embodiment of the present disclosure, a biometric recognition device for palm prints and palm veins is provided. The biometric recognition device is capable of clearly obtaining palm print and palm vein information at the same time and in the same space.

According to an example of the present disclosure, the biometric recognition device 10 may include a light source 100, a polarizing unit 200, an imaging unit 300, a polarizing beam splitter 400, a first image sensor 500, and a second image sensor 600.

The light source may be used to emit illuminating beams in a near-infrared band. For example, the near-infrared band ranges from 760 nm to 1100 nm. Different from the existing technology, only the illuminating beams in the near-infrared band is used to obtain palm print characteristic information and palm vein characteristic information.

The polarizing unit 200 may be provided in the beams path of the illuminating beams reaching the palm of the person. The polarizing unit 200 may be used to polarize the beams emitted by the light source to form polarized beams. The polarized beams can illuminate the surface skin of the palm. In the present disclosure, a part of the polarized beams is reflected by the surface skin of the palm to form first retroreflected beams S1. A polarization direction of the first retroreflected beams S1 is the same as a polarization direction of the polarized beams. The other part of the polarized beams passes through the surface skin of the palm and reach the interior tissue of the palm. The other part of the polarized beams forms some beams by scattering and diffuse reflection. The polarization directions of some beams are changed. These beams include second retroreflected sub-beams Pl and second retroreflected sub-beams S2. A polarization direction of the second retroreflected sub-beams P1 is perpendicular to the polarization direction of the polarized beams. A polarization direction of the second retroreflected sub-beams S2 is the same as the polarization direction of the polarized beams. The combined beams (second retroreflected beams) of the second retroreflected sub-beams Pl and the second retroreflected sub-beams S2 pass through the surface skin of the palm again, and enter the imaging lens 300 together with the first retroreflected beams S1 reflected by the surface skin of the palm.

In the present disclosure, only one kind of illuminating beams and one imaging lens are used. The one imaging lens is used to receive the first retroreflected beams and the second retroreflected beams.

The imaging unit 300 may be used to converge the beams from a palm information obtaining area to a focal plane. After the illuminating beams irradiate the palm, the polarization directions of the illuminating beams are changed. Therefore, the imaging unit 300 is used to converge the first retroreflected beams and the second retroreflected beams to the same focal plane. By this way, it is possible to avoid the solution of the prior art in which two light sources of different wavelength bands are used, and thus two imaging units are used to converge two types of beams respectively.

The polarizing beam splitter 400 receives the beams from the imaging unit 300. The beams from the imaging unit include the first retroreflected beams and the second retroreflected beams. The polarizing beam splitter 400 forms transmitted beams and reflected beams, based on the different polarization directions of the beams from the imaging unit 300. The transmitted beams formed by the polarizing beam splitter propagate through the polarizing splitter, and the reflected beams formed by the polarizing beam splitter propagate after being reflected by the polarizing beam splitter.

For example, the transmitted beams formed by the polarizing beam splitter have the polarization direction which is the same as that of the polarized beams, and the reflected beams formed by the polarizing beam splitter have the polarization direction which is perpendicular to the that of the polarized beams. Otherwise, the reflected beams formed by the polarizing beam splitter have the polarization direction which is the same as that of the polarized beams, and the transmitted beams formed by the polarizing beam splitter have the polarization direction which is perpendicular to the that of the polarized beams.

The polarizing beam splitter 400 may be in the form of a polarizing beam splitting prism, and may be made by a coating process. For example, a polarizing beam splitting film is coated inside the prism. Depending on the differences of the polarization directions of the beams, a first light path and a second light path are formed by the beam splitting film. The first light path includes the beams (the transmitted beams or the reflected beams) of which the polarization direction is the same as the polarization direction of the polarizing beams. The second light path includes the beams (the reflected beams or the transmitted beams) of which the polarization direction is perpendicular to the polarization direction of the polarizing beams.

Specifically, the polarizing beam splitting prism divides the beams into the light path of the reflected beams and the light path of the transmitted beams, based on the different polarization directions, to form images respectively. Depending the coating process, the coated film can be configured to achieve two different functions.

The first function is as follows. The first retroreflected beams S1 and the second retroreflected sub-beams S2 are allowed to pass through the coated film to form the transmitted beams. Accordingly, the first image sensor 500 form an image corresponding to S-polarized beams (S1+S2). The image shows an obvious palm print pattern (the imaging of the first retroreflected beams S1) and a weak palm vein pattern (the imaging of the second retroreflected sub-beams S2). The second retroreflected sub-beams P1 is reflected by the coated film, and the reflected beams reach the second image sensor 600 to form an obvious palm vein pattern. Since the S-polarized beams formed by reflection of the surface skin of the palm pass through the polarizing beam splitter prism and does not reach the second image sensor 600, the image formed by the second image sensor 600 does not show the palm print pattern.

The second function is as follows. The second retroreflected sub-beams Pl are allowed to pass through the coated film, and the first image sensor 500 forms an image based on the second retroreflected sub-beams P1. The image shows an obvious palm vein pattern. The first retroreflected beams S1 and the second retroreflected sub-beams S2 are reflected by the coated film to form the reflected beams reaching the second image sensor 600. An image formed by the second image sensor 600 shows an obvious palm print pattern (the imaging of the first retroreflected beams S1) and a weak palm vein pattern (the imaging of the second retroreflected sub-beams S2). Since the S-polarized beams formed by reflection of the surface skin of the palm are reflected by the polarizing beam splitter prism and does not reach the first image sensor 500, the image formed by the first image sensor 500 does not show the palm print pattern.

In this disclosure, only the coated surface of the polarizing beam splitter prism is formed using different coating settings. The first image sensor and the second image sensor are only used to receiving beams. The positions of the first image sensor and the second image sensor can be exchanged.

According to a further embodiment of the present disclosure, an optical color filter 700 may be provided. The optical color filter 700 may be disposed in the optical path between the palm and the first image sensor or the second image sensor, to filter out beams outside the expected band. For example, the optical color filter 700 is disposed between the palm and the imaging unit, between the imaging unit and the polarizing beam splitter, between the polarizing beam splitter and the first image sensor, and/or between the polarizing beam splitter and the second image sensor.

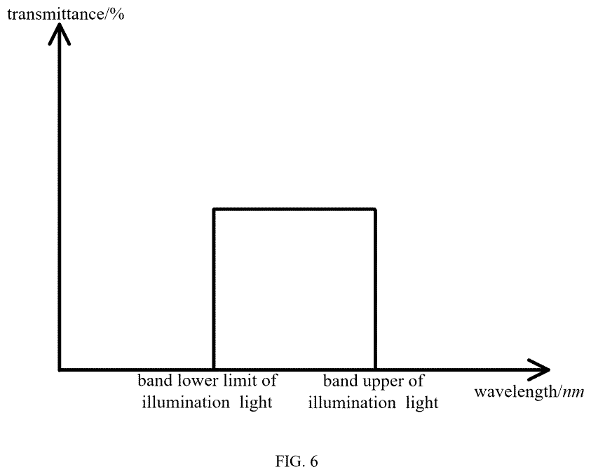

The optical color filter 700 may be in the form of a film. The coating parameters can be set to allow beams of a band emitted by the light source to pass through, and to block beams in other bands from passing through. By only allowing beams of the band emitted by the light source to pass through, the imaging influence of beams in other bands such as visible beams can be eliminated, thereby forming a clear palm vein image. For example, as shown in FIG. 6, the optical color filter 700 may be a bandpass filter allowing beams in the band emitted by the light source to pass through, and blocking beams in other bands from passing through, thereby eliminating external stray beams and simultaneously improving the quality of the palm vein image and the quality of the palm print image.

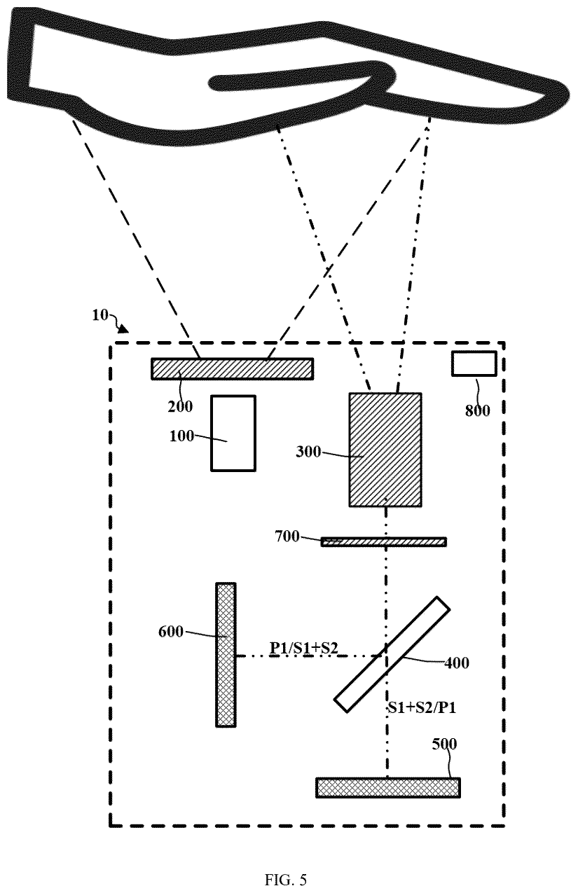

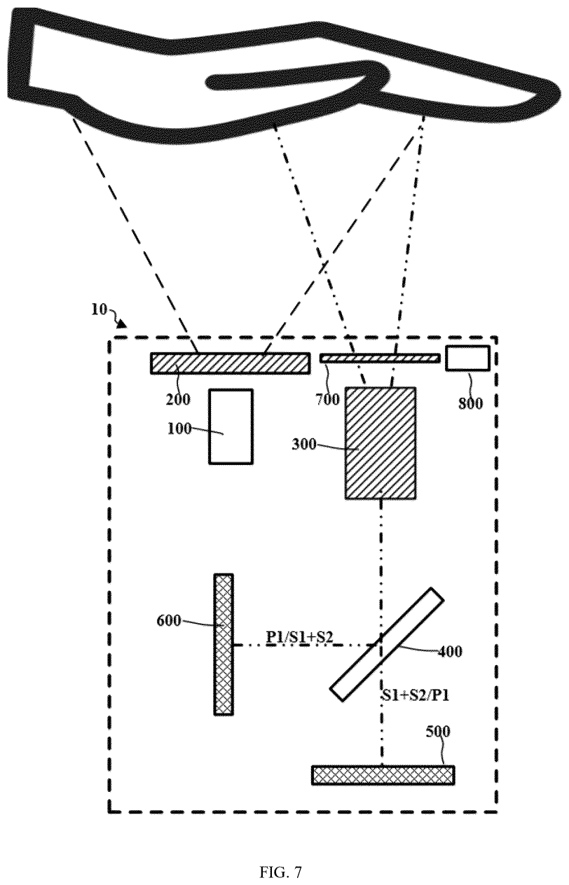

FIG. 5 shows a situation where the optical color filter 700 is provided between the imaging unit 300 and the polarizing beam splitter 400. FIG. 7 shows a situation where the optical color filter 700 is provided between the palm and the imaging unit 300. In both situations, the transmitted beams formed by the polarizing beam splitter may be the beams of the first retroreflected beams S1 and the second retroreflected sub-beams S2 and the reflected beams formed by the polarizing beam splitter may be the beams of the second retroreflected sub-beams P1. Alternatively, the reflected beams formed by the polarizing beam splitter may be the beams of the first retroreflected beams S1 and the second retroreflected sub-beams S2 and the transmitted beams formed by the polarizing beam splitter may be the beams of the second retroreflected sub-beams P1.

In addition, in the present disclosure, the optical color filter part 700 may also be provided between the polarizing beam splitter 400 and the first image sensor 500 and/or the second image sensor 600.

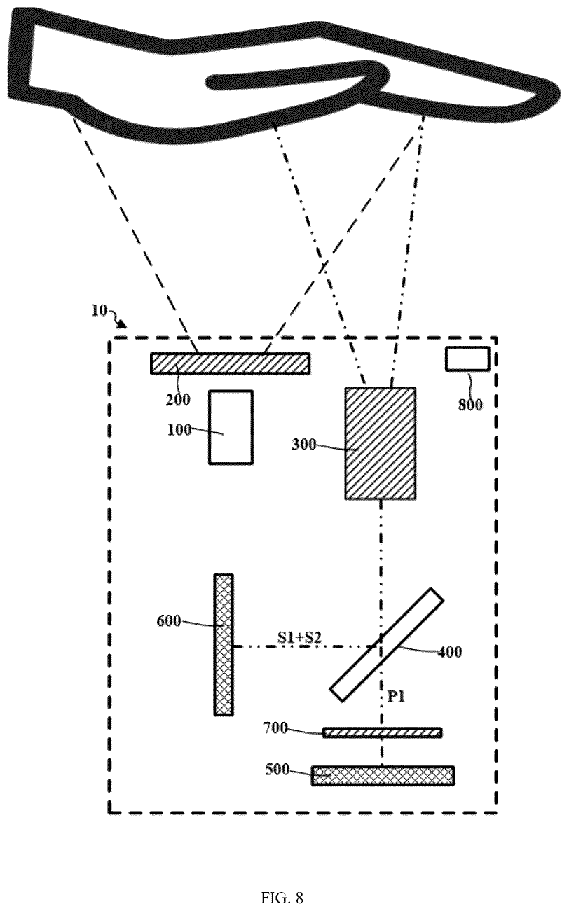

For example, FIG. 8 shows a situation where the optical color filter 700 is provided between the polarizing beam splitter 400 and the first image sensor 500. In the situation, the polarizing beam splitter 400 is configured to allow the second retroreflected sub-beams P1 to pass through, and reflect the first retroreflected beams S1 and the second retroreflected sub-beams S2. The transmitted beams according to the second retroreflected sub-beams P1 pass through the optical color filter 700 to eliminate external stray beams, thereby the first image sensor 500 forms a clear palm vein image. The reflected beams formed by the reflection of the first retroreflected beams S1 and the second retroreflected sub-beams S2 are form as a palm print image in the second image sensor 600.

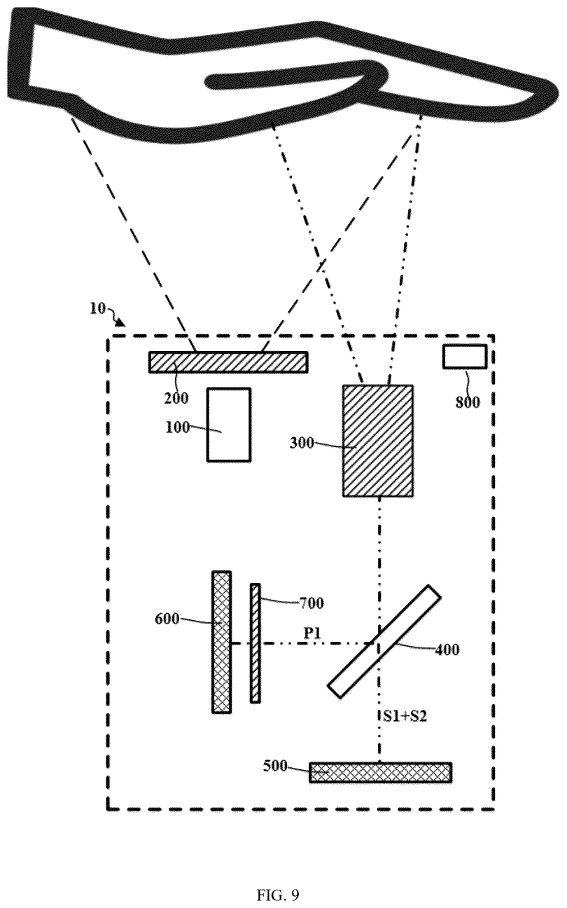

For example, FIG. 9 shows a situation where the optical color filter 700 is provided in the polarizing beam splitter 400 and the second image sensor 600. In this situation, the polarizing beam splitter 400 is configured to reflect the second retroreflected sub-beams P1, and allow the first retroreflected beams S1 and the second retroreflected sub-beams S2 to transmit. The reflected beams according to the second retroreflected sub-beams P1 pass through the optical color filter 700 to eliminate external stray beams, thereby the second image sensor 600 forms a clear palm vein image. The transmitted beams according to the first retroreflected beams S1 and the second retroreflected sub-beams S2 are form as a palm print image in the first image sensor 500.

According to a further embodiment of the present disclosure, a distance sensor 800 may also be included. The distance sensor 800 is used to measure the distance between the palm and the device. When the distance of the palm is less than a predetermined distance, the light source 100, the first image sensor 500 and the second image sensor 600 are turned on.

Based on the non-contact technical solution of the present disclosure, only one light source is used to obtain palm print images and palm vein images at the same time and in the same space, to complete information extraction in the biometric recognition process of characteristics of the palm prints and palm veins. The present disclosure can effectively solve the problems existing in the prior art.

According to another embodiment of the present disclosure, an identity authentication method is also provided. The identity authentication method may use the biometric recognition device for palm prints and palm veins as described above.

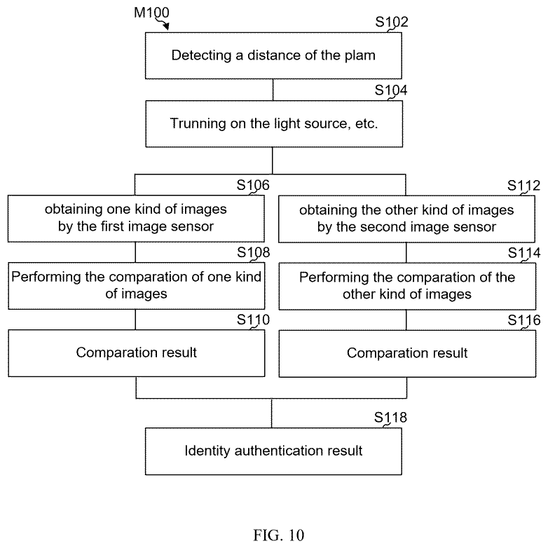

As shown in FIG. 10, the identity authentication method M100 may include the following steps.

In step S102, the biometric recognition device may be used to continuously detect whether a palm approaches the biometric recognition device. For example, the distance sensor 800 is used for measurement. When the distance sensor 800 detects that the distance of the palm is less than the predetermined distance, the method proceeds to step S104. In the step S104, the light source 100, the first image sensor 500 and the second image sensor 600 are turned on.

In step S106, the first image sensor forms one image. In step S108, the one image formed by the first image sensor is compared with pre-stored feature information. In step S110, the comparison result is output to complete the first identity authentication.

In step S112, the second image sensor forms the other image. In step S114, the other image formed by the second image sensor is compared with the pre-stored feature information. In step S116, the comparison result is output to complete the second identity authentication.

The above-mentioned one image and the other image are a palm print image and a palm vein image respectively.

In step S118, a final identity authentication may be implemented based on the first identity authentication and the second identity authentication, and the final identity authentication result may be output.

In the description of this specification, reference to the description of “one embodiment/implementation”, “some embodiments/implementations”, “example”, “specific example” or “some examples”, and the like means that a specific feature, structure, material, or characteristic described in conjunction with the embodiment/implementation or example is included in at least one embodiment/implementation or example of the present disclosure. In this specification, the schematic descriptions of the foregoing terms do not necessarily refer to the same embodiment/implementation or example. In addition, the specific feature, structure, material, or characteristic described may be combined in any one or more embodiments/implementations or examples in an appropriate manner. In addition, on the premise of no conflict, those skilled in the art may combine different embodiments/implementations or examples and features of the different embodiments/implementations or examples described in this specification.

In addition, the terms “first” and “second” are only intended for a purpose of description, and cannot be understood as indicating or implying relative importance or implicitly indicating the quantity of indicated technical features. Therefore, a feature limited by “first” or “second” may explicitly or implicitly include at least one of the features. In the descriptions of the present disclosure, unless otherwise explicitly and specifically limited, the term “a plurality of” means at least two, for example, two, three, and the like.

Those skilled in the art should understand that the foregoing implementations are only for clearly describing the present disclosure and not intended to limit the scope of the present disclosure. For those skilled in the art, other changes or variations may further be made based on the foregoing disclosure, and these changes or variations also fall within the scope of the present disclosure.

What is claimed is:

1. A biometric recognition device for palm prints and palm veins, comprising:
a light source being used to emit illuminating beams in a near-infrared band;
a polarizing unit being used to convert the illuminating beams to polarized beams, wherein the polarized beams are emitted to a palm;
an imaging unit receiving retroreflected beams from the palm and being used to converge the retroreflected beams to a focal plane;
a polarizing beam splitter forming transmitted beams and reflected beams based on different polarization directions of beams from the imaging unit, wherein the transmitted beams propagate after pass through the polarizing beam splitter, and the reflected beams propagate after reflected by the polarizing beam splitter;
a first image sensor receiving the transmitted beams from the polarizing beam splitter to form one kind of palm print images and palm vein images; and
a second image sensor receiving the reflected beams from the polarizing beam splitter to form other kind of the palm print images and the palm vein images.

2. The biometric recognition device of claim 1, wherein a polarization direction of the transmitted beams is identical toa polarization direction of the retroreflected beams, and a polarization direction of the reflected beams is perpendicular to the polarization direction of the retroreflected beams.

3. The biometric recognition device of claim 1, further comprising an optical color filter, wherein the optical color filter is disposed in a light path between the palm and the first image sensor or the second image sensor to filter out beams outside an expected band.

4. The biometric recognition device of claim 3, wherein the optical color filter is disposed between the palm and the imaging unit, between the imaging unit and the polarizing beam splitter, between the polarizing beam splitter and the first image sensor, and/or between the polarizing beam splitter and the second image sensor.

5. The biometric recognition device of claim 1, wherein the near-infrared band ranges from 760 nm to 1100 nm.

6. The biometric recognition device of claim 1, wherein the illuminating beams are arranged such that one a first part of the polarized beams is reflected by a surface skin of the palm to form first retroreflected beams, and a second part of the polarized beams, after passes through the surface skin of the palm and reaches an internal tissue of the a palm tissue, is scattered and diffused to form second retroreflected beams, wherein a polarization direction of the first retroreflected beams is identical to a polarization direction of the polarized beams, and the second retroreflected beams at least comprise second retroreflected sub-beams having a polarization direction being perpendicular to the polarization direction of the polarized beams.

7. The biometric recognition device of claim 6, wherein the second retroreflected beams further comprise second retroreflected sub-beams having a same polarization direction as the polarized beams.

8. The biometric recognition device of claim 12, wherein the polarizing beam splitting film is configured such that the first retroreflected beams and the second retroreflected sub-beams having the same polarization direction as the polarized beams pass through the polarizing beam splitting film to form the transmitted beams, and the second retroreflected sub-beams having the polarization direction being perpendicular to the polarization direction of the polarized beams are reflected to form the reflected beams.

9. The biometric recognition device of claim 1-any one of claims 1 to 8, further comprising a distance sensor, wherein the distance sensor is used to measure a distance of the palm, and the light source, the first image sensor, and the second image sensor are turned on when the distance of the palm is less than a predetermined distance.

10. (canceled)

11. The biometric recognition device of claim 1, wherein a polarization direction of the transmitted beams is perpendicular to a polarization direction of the retroreflected beams, and a polarization direction of the reflected beams is identical to the polarization direction of the retroreflected beams.

12. The biometric recognition device of claim 7, wherein the polarizing beam splitter is coated with a polarizing beam splitting film to separate the beams from the imaging unit into the transmitted beams and the reflected beams.

13. The biometric recognition device of claim 12, wherein the polarizing beam splitting film is configured such that the second retroreflected sub-beams having the polarization direction being perpendicular to the polarization direction of the polarized beams pass through the polarizing beam splitting film to form the transmitted beams, and the first retroreflected beams and the second retroreflected sub-beams having the same polarization direction as the polarized beams pass through the polarizing beam splitting film to form the reflected beams.
